(19) United States
(12) Patent Application Publication
(10) Pub. No.: US 2016/0278399 A1
(43) Pub. Date: Sep. 29, 2016

(54) HEAT STABLE CHOCOLATE CONFECTIONERY PRODUCT AND METHOD OF MAKING SAME

(71) Applicant: THE HERSHEY COMPANY, Hershey, PA (US)

(72) Inventors: Xiaoying WANG, Hummelstown, PA (US); Maria Jose PEREZ GONZALEZ, Hummelstown, PA (US); Burton Douglas BROWN, Hershey, PA (US); Susan Marie BENJAMIN, Harrisburg, PA (US); Carey HOFFMAN, River Ridge, LA (US); David WORTHING, Middletown, PA (US); Dennis TEETS, Grantville, PA (US)

(73) Assignee: THE HERSHEY COMPANY, Hershey, PA (US)

(21) Appl. No.: 14/911,767

(22) PCT Filed: Sep. 15, 2015
(86) PCT No.: PCT/US2015/050082

§ 371 Date: Feb. 12, 2016

Related U.S. Application Data
(60) Provisional application No. 62/050,380, filed on Sep. 15, 2014.

(51) Int. Cl. A23G 1/40; A23G 1/46

(52) U.S. Cl. CPC A23G 1/40; A23G 1/46; A23V 2002/00

(57) ABSTRACT

Provided are a process for forming a heat stable confectionery product and a heat stable confectionery product. The process for forming a heat stable confectionery product comprises carrying out a first process sequence comprising formulating a blend of a sweetener, a confectionery fat along with milk solids, cocoa solids or both, and conching the blend; providing a pre-sized sugar hydrate additive; and adding the sugar hydrate additive to the blend at the end of the first sequence to form a flowable confectionery paste, followed by cooling the confectionery paste to a solid. The heat stable confectionery product includes sugar hydrate, is visibly devoid of blooming, and is formed according to the process described above.

### CROSS-REFERENCE TO RELATED APPLICATION

This application claims the benefit of and priority to U.S. Provisional Patent Application No. 62/050,380 filed on Sep. 15, 2014, which is hereby incorporated by reference in its entirety.

### FIELD

This application is directed to the manufacture of confectionery products and more particularly to the manufacture of heat stable chocolate and chocolaty candy.

### BACKGROUND

Traditional chocolate making methods are well known and involve several basic steps carried out in a particular order. Generally, the process starts with cocoa beans harvested from pods of melon-like fruit that grow on the cacao tree. The cocoa beans are removed from the pods and placed in large heaps or piles to ferment, during which the shells of the beans harden and darken and a rich cocoa flavor develops.

Dried cocoa beans are roasted at very high temperatures and hulled to separate the shell from the inside of the bean, also called a “nib,” the part of the bean actually used to make chocolate. The nibs are milled by a grinding process that turns the nibs into a liquid called chocolate liquor.

The chocolate liquor, which is sometimes separated in advance into its constituents, cocoa butter and cocoa powder, is mixed with a sweetener, usually sugar, and in the case of milk chocolate, milk solids are also added.

The mixture is refined and then conched, a process in which the chocolate powder is maintained above the fat melting temperature while mixing elements smooth out gritty particles, remove moisture and off-flavors, and develop pleasant flavors. Conching also releases fat, increasing fat coating on particles so that the chocolate has a proper fluidity for further processing. Additional fat is added to achieve the full formulated fat content and emulsifiers are also added to reduce viscosity and enhance fluidity of the chocolate paste. The liquid chocolate paste is tempered and then poured or deposited into a mould to produce a chocolate bar or used for enrobed products.

The melting temperature of cocoa butter and other fats sometimes used with or in place of cocoa butter in certain chocolate making processes is in the range of 29° C. to 35° C. As a result, chocolate bars and other chocolate confections cannot always be readily transported, stored or enjoyed in the summertime or in tropical climates where temperatures of unconditioned spaces typically reach or exceed the melting point of the fat in the chocolate. Even where the confections are stored or consumed in a conditioned space, if they melt during transit and then resolidify, the products may become misshapen or exhibit bloom, a condition in which the melted fat in the chocolate recrystallizes in a different structure resulting in a change in appearance or texture that can render the product unappealing.

Various attempts have been directed to trying to develop a heat stable chocolate that could better withstand conditions of elevated temperature. Many of those efforts have involved the use of high melting temperature fats or the direct addition of water into chocolates in the form of foam, sugar-crystal hydrates or water-in-oil emulsions, or using hydroscopic substances such as amorphous sugars or polyols. The use of high melting temperature fats negatively affects taste and other eating properties of the resulting product, while the other methods cause difficulty in chocolate processing and also negatively affects eating quality.

Several prior attempts relate to the addition of dextrose monohydrate as a sugar hydrate to add water to the chocolate and increase heat stability, but to date nothing has still provided heat stability in combination with a product that has an eating quality as good as or comparable to traditional chocolate.

These and other drawbacks are associated with current methods of confectionery production.

### SUMMARY

Exemplary embodiments are directed to producing chocolate confectioneries that make use of a sugar hydrate to produce a heat stable product, but which does not require significant changes in traditional chocolate processing steps. Further, the resulting product retains many of the same eating qualities as a traditional chocolate and uses only small amounts of sugar hydrate in place of sugar.

In one embodiment, a process for forming a heat stable product comprises carrying out a first process sequence comprising formulating a blend of a sweetener and a confectionery fat along with milk solids, cocoa solids or both, conching the blend, and tempering that blend when the confectionery fat is a tempering fat; providing a sugar hydrate additive; and adding the sugar hydrate additive to the blend at the end of the first sequence to form a flowable confectionery paste, followed by cooling the confectionery paste to a solid.

In one embodiment, the sugar hydrate is dextrose monohydrate, the confectionary fat is cocoa butter, and the first sequence further comprises standardizing the blend after conching.

In another embodiment, the sweetener comprises sucrose and at least 4% by weight amorphous sweetener.

In another embodiment, a heat stable confectionery product is visibly (i.e., macroscopically) devoid of any appearance of blooming and includes the product formed by carrying out a first process sequence comprising formulating a blend of cocoa solids, sweetener, and a confectionery fat (e.g., non-tempering fat, CBS), and conching the blend; providing a sugar hydrate additive; and adding the sugar hydrate additive to the blend at the end of the first sequence to form a flowable confectionery paste, followed by cooling the confectionery paste to a solid.

In some embodiments, the first process sequence also includes refining the blend intermediate the steps of formulating and conching, while in other embodiments, the first process sequence includes formulating a blend of pre-ground cocoa solids (e.g., refined or balled), pre-ground dry blends of sweeteners and milk powders, and confectionery fats, then conching the blend and standardizing the blend.

In another embodiment, the first process sequence is an all-in ball milling of a blend of sweeteners, cocoa solids, milk powders, confectionery fats, and emulsifiers. The Sugar hydrate additives are added to the blend at the end of the first process sequence, forming a flowable confectionery paste. When a tempering fat is used, the sugar hydrate additives are added into a tempered paste.

An advantage is that the first process sequence can be carried out under traditional chocolate making conditions involving elevated temperatures well in excess of the fat melting temperature to enhance the flavor profile without compromising the subsequent ability to form a heat stable chocolate.

Another advantage is that the sugar hydrate is processed and added under conditions that prevent its dehydration during processing that would otherwise create difficulty in the chocolate making process and cause poor eating quality of the finished product.

Yet another advantage of processing the sugar hydrate into smaller particle size is that it enhances the sugar hydrate's subsequent ability to form a heat stable chocolate by lowering the temperature at which dehydration occurs.

Still another advantage is that methods in accordance with exemplary embodiments can produce chocolate confections that have a stable texture at elevated temperatures, but still having a taste and texture, as well as shelf life, comparable to chocolate confections produced by traditional methods particularly including being virtually indistinguishable from the traditional chocolate in texture and mouthfeel when the products have not been exposed to elevated temperatures.

Other features and advantages of the present invention will be apparent from the following more detailed description of exemplary embodiments, taken in conjunction with the accompanying drawings which illustrate, by way of example, the principles of the invention.

### DETAILED DESCRIPTION OF EXEMPLARY EMBODIMENTS

Exemplary embodiments are directed to methods of producing a confectionery product that includes a first process sequence that involves traditional chocolate making steps of refining (e.g., reducing particle size) and conching, and which may also continue through the steps of standardizing and/or tempering, such as may be desirable or necessary when a tempering fat is employed. Separately, a sugar hydrate additive is provided via a second stream and added at the conclusion of the first process sequence that results in a flowable paste that can be used to form bars or in shell molding applications. The paste is thereafter cooled to a solid and the resultant product is ready for packaging.

It will be appreciated that the term “chocolate” may have a legal definition in certain countries relative to particular amounts of cocoa solids, cocoa butter or other ingredients, such as milk fat and/or milk powder, and that the definition may vary from country to country. As used herein, however, the term “chocolate confection” or “chocolate confectionery product” is meant to encompass the broad category of any confectionery product that includes a chocolate compatible fat, including traditional chocolate containing cocoa solids and cocoa butter, as well as those products sometimes referred to as chocolaty candy or chocolate compound that make use of additional fats and/or chocolate flavorings in place of cocoa solids and/or cocoa butter, along with the category of candy known as white chocolate.

According to exemplary embodiments, the first process sequence involves formulating a blend of chocolate making ingredients in accordance with any desired recipe for a particular flavor profile in the final composition of the paste to be formed. Such ingredients typically include at least a sweetener, cocoa solids (optional in the case of white chocolate confections), and milk solids (optional in the case of dark chocolate confections) as well as emulsifiers mixed with a fat. The fat in the blend can be cocoa butter and/or other confectionery fats such as those known in the industry as cocoa butter equivalents (CBE), cocoa butter substitutes (CBS), cocoa butter replacements (CBR), and/or cocoa butter improvements (CBI) as well as anhydrous milk fat (AMF) and milk fat replacers.

While the mixture typically includes cocoa solids, these may be eliminated, for example, in methods for producing certain confections, including those commonly referred to as white chocolate. For embodiments in which cocoa solids are used, they may be introduced, for example, as cocoa powder and/or as chocolate liquor in which the cocoa solids are not yet separated from the cocoa butter.

The sweetener is preferably, but not necessarily, sugar, with a majority typically in the form of sucrose. Other sweeteners may include lactose, polyols, corn syrup solids, and fructo-oligosaccharide/inulin, by way of example only.

The milk solids are typically introduced in the form of whole milk powder (WMP) and/or non fat dry milk powder (NFDM).

In some embodiments of the invention, a portion of the sweetener content is in the form of amorphous sweetener. In one embodiment, the amorphous sweetener content is at least 4% by weight of the ultimately formed paste, and preferably is greater than 6% by weight. The amorphous sweetener content can be introduced via amorphous sugar present in the WMP or NFDM, such as lactose. Additionally or alternatively, the amorphous sweetener content can be achieved through the introduction of non-dairy powders such as whey powder or whey permeates (e.g., in white chocolate products), amorphous lactose, amorphous polyols, or any other amorphous form of sugar or sugar sweeteners, including corn syrup solids or cotton candy, for example, in formulating the blend of the first process sequence.

The confectionery fat is preferably cocoa butter, but as briefly noted previously, any of the vegetable or other fats known in the chocolate industry for use in combination with or in place of cocoa butter may also be employed. Such fats are typically classified as one of the following categories: cocoa butter equivalents (e.g., fractionated palm oil, illipe and shea nut butter), cocoa butter replacements (e.g., fractionated and partially hydrogenated soybean, cottonseed and palm oils), cocoa butter substitutes (e.g., fractionated and partially hydrogenated lauric fat compounds), and cocoa butter improver (e.g., fractionated, shea, palm oil, and illipe). The confectionery fat may be any of the foregoing categories of fats or may be a combination of one or more types of fats from different categories.

Emulsifiers that may be used include lecithin, polyglycerol polyricinoleate (PGPR), and ammonium phosphatide (YN), by way of example only.

It will further be appreciated that flavorants, such as natural vanilla, vanillin or other extracts, as well as preservatives, such as tocopherols, and other minor ingredients known in the art for chocolate confectionery formulations may also be blended into the mixture.

After the initial formulation of the blend for the first process sequence, the resulting mass is refined to the desired particle size. Refining is followed by conching at temperatures in excess of 45° C., preferably in excess of 50° C., typically for about one hour, although shorter and longer times are contemplated. In an alternate embodiment, the first process sequence includes forming the blend from pre-ground (e.g., refined or balled) cocoa solids, pre-ground dry blends of sweeteners and milk powder, and confectionery fats. In another alternate embodiment, the first process sequence includes an all-in ball milling of a blend of sweeteners, cocoa solids, milk powders, confectionery fats, and emulsifiers. When formed from pre-ground cocoa solids and/or pre-ground dry blends, or as an all-in ball milling, the resulting mass may be conched without refining first.

Commercial alpha-dextrose monohydrate dehydrates above 45° C. Thus, prior art processes that employed this sugar hydrate in formulating heat stable chocolate have required conching at a controlled temperature less than 40° C. or in some cases in the range of 35° C.-45° C. However, an ordinary chocolate process usually has a conching step at temperature above 45° C., preferably above 50° C. Conching at these elevated temperatures removes off flavor and moisture from chocolate liquor, and develops caramelized pleasant notes needed in certain type of chocolate, which is not accomplished at temperatures lower than 50° C.

Because exemplary embodiments do not introduce the sugar hydrate additive until after the completion of the first process sequence, this sequence can be carried out at normal elevated temperature and time frames associated with traditional chocolate making to achieve the desired flavor results. In some embodiments, the first process sequence is complete after conching, while in other embodiments, the composition may be standardized following conching. Standardizing the composition includes, for example, the addition of emulsifiers to achieve a desired viscosity for an end use of the paste, such as for bar moulding or shell forming.

Similarly, for confectioneries that employ cocoa butter or other tempering fats as the confectionery fat, the first process sequence also involves tempering following conching and any standardization.

The invention also entails providing a sugar hydrate additive that is added following completion of the first process sequence. The sugar hydrate of the sugar hydrate additive preferably is or comprises dextrose monohydrate.

In some embodiments, the sugar hydrate additive consists solely of the sugar hydrate. In other embodiments, the sugar hydrate additive is a blend of sugar hydrate with cocoa powder, corn starch or another dry ingredient as a flow-aid. In other embodiments, the sugar hydrate additive is a sugar hydrate blended with a confectionery fat. In each case, the sugar hydrate particles are pre-sized and/or reduced to a particle size less than 60 microns, typically less than 40 microns and in some embodiments the particle size ranges from about 20 to about 40 microns, with particle size determined using the micrometer method as known to those in the confectionery art for measuring particle sized. Pre-sizing the sugar hydrate to smaller particle size is readily accomplished using low temperature mills, such as low temperature roller refiner or a jet pulverizer for incorporation into the premade chocolate composition of the first process sequence. The sugar hydrate is milled at low temperatures, preferably less than 35° C. such as less than 32° C. The low temperature size reduction prevents dehydration of the water molecule from the sugar and ensures the sugar hydrate retains that functionality for subsequent formation of heat stable chocolate confections.

In the case of pure sugar hydrate or a blend of sugar hydrate and cocoa powder, particle size reduction and/or pre-sizing can be accomplished by milling to the smaller particle size using, for example, a jet pulverizer. Any low temperature milling technology may be employed, including jet milling, such as the milling techniques described, for example, in U.S. Pat. No. 5,637,344 which is herein incorporated by reference.

. Where an additional dry ingredient is added to the sugar hydrate as a flow aid, it is typically added up to about 10% by weight, typically about 1% to about 5% by weight, such as about 3% by weight, of the sugar hydrate being pulverized. Suitable flow aids include, but are not limited to, starches, fibers, phosphates, e.g. tricalcium phosphate, carbonates, e.g. calcium carbonate, silicates, e.g. calcium silicate, gluconates, e.g. calcium gluconate, and combinations thereof.

The jet pulverizing is performed in an environment less than 32° C. and preferably less than 25° C. and with a humidity less than 60%, preferably less than 50% so that the pulverized powder leaving the jet mill is less than 35° C., such as less than 32° C., preferably less than 30° C., to prevent dehydration of dextrose.

In other embodiments, the desired particle size of the sugar hydrate can be accomplished through the use of a roll refiner and in these embodiments the sugar hydrate is combined with cocoa butter, milk fat, or other confectionery fat. The fat is present from about 22% to about 35% by weight of the sugar hydrate. The fat temperature at addition is less than 42° C., preferably less than 40° C. A small amount of emulsifiers, such as lecithin (e.g., about 0.1%) can also be added.

The temperature of the roller refiner's rolls should be controlled to 32° C. or below, preferably less than 30° C., so that the discharged material exiting the roller is less than 35° C. and preferably less than 33° C. and more preferably less than 30° C. to decrease the likelihood of premature water release by the hydrate.

Reducing the sugar hydrate particle size is believed to result in a looser bond between the sugar and the water molecules of the hydrate compared to the original crystalline structure, which provides a decreased dehydration temperature of the sugar hydrate. This makes the water molecules more readily available to the amorphous sugar components in the formula to which the sugar hydrate is then added at the conclusion of the first process sequence. Additionally, the looser bond and/or decreased dehydration temperature permits development of heat stability without an additional thermal curing step.

It will be appreciated that the amounts of the ingredients blended in the first process sequence will depend upon the type and/or size of sugar hydrate additive employed and may be adjusted accordingly with respect to the overall formulation of the paste being formed. For example, in embodiments in which the sugar hydrate is refined in a confectionery fat, the amount of fat introduced can be reduced by a corresponding amount used in formulating the initial blend of the first process sequence.

It will be further appreciated that the amount of sugar added to the formulation of the first process sequence can likewise be adjusted based on the type and amount of sugar hydrate that will be added later at the completion of that sequence. For example, in certain embodiments in which the sugar hydrate is dextrose monohydrate, the water equivalent of the dextrose monohydrate is about 0.18% to about 1.80%. That is, the ultimate paste composition (formed by the addition of the pre-sized sugar hydrate additive to the composition that was pre-formed during the first process sequence) is preferably from about 2% to about 20% by weight dextrose monohydrate, more preferably from about 2% to about 10% by weight and in some embodiments is from about 2% to about 7% by weight dextrose monohydrate, such as about 2% to about 4% or about 5% to about 7% by weight dextrose monohydrate.

As discussed, the provided pre-sized and/or reduced size sugar hydrate additive is introduced at the completion of the first process sequence. In the case of tempered confections, the sugar hydrate additive is mixed into the tempered chocolate when the temperature of that chocolate has decreased below 33° C., preferably less than 30° C. Mixing may be accomplished using conventional mixing equipment such as a batching Hobart mixer, high shear mixer, ribbon blender, or a continuous mixer, all by way of example. For non-tempering chocolate compound pastes, the pre-sized sugar hydrate additive is added as the composition has cooled to temperatures of about 40° C. or less, preferably 35° C. or less, more preferably 32° C. or less, following conching and/or any standardization to complete the first process sequence.

The resulting paste now inclusive of the sugar hydrate and in its final formulation can be molded into pieces and/or used for other applications, such as shell moulding, followed by cooling to solid form resulting in a finished chocolate or other confectionery product which is then ready for packaging and shipping.

Among the advantages of exemplary embodiments are that the chocolate confections produced in accordance with methods described herein do not require any post production thermal treatment steps, such as baking or microwaving, to render them heat resistant. To the contrary, because the water has not yet been released, the chocolate retains the same characteristics of taste, mouthfeel, and texture at lower temperatures as a traditional chocolate. Additionally, blooming in the chocolate is decreased or eliminated. However, if the confection is stored in an unconditioned space or otherwise subjected to high temperature conditions, the water within the sugar hydrate is released, upon which the confection cures and thereby develops heat stability. For example, when stored at temperatures of between 65° F. (18.3° C.) and 75° F. (23.4° C.) for at least four weeks, the confection develops moderate heat stability, while storage at higher temperatures increases the developed heat stability.

Prior art processes that employ unprocessed, commercially available dextrose monohydrate require thermal curing, micro-wave heating or baking process. This heating process de-tempers cocoa butter in chocolate and results in a bloomed chocolate of bad appearance. In accordance with exemplary embodiments, pre-sizing of dextrose monohydrate reduced its dehydration energy such that dextrose liberates water at lower temperatures that are more likely to be experienced naturally in unconditioned spaces and eliminating the need for advance thermal processing. Jet pulverized dextrose powder showed dehydration at temperature of 35° C. or less, roller refined powder at 40° C. or less, which is compared to a dehydration temperature of 45° C. or higher for commercially available dextrose monohydrate.

Chocolate confections incorporated with the processed pre-sized dextrose monohydrate in accordance with exemplary embodiments do not need any post-processing thermal-curing step, such as baking or microwaving. Instead, the chocolate confections develop heat stability where a warm temperature is presented, such as a non temperature controlled retail shop in a tropical country. As a result, chocolate confections in accordance with exemplary embodiments can leave the production facility without exhibiting any blooming introduced by the thermal processing steps necessary in currently known methods.

It will be appreciated that the degree of heat stability of the chocolate depends on conditions. The higher the temperature, the shorter the time needed to develop the heat stability, and the firmer the chocolate became. For example, at 35° C., heat stability developed in 7 hours or less while at 49° C., heat stability developed in 1 hour or less.

It was also observed that the higher the amount of dextrose monohydrate in the chocolate, the shorter the time needed, and the firmer the chocolate became. Under temperature controlled storage condition, water is still “coordinated” with dextrose and did not react with amorphous sugar and/or protein in the chocolate, therefore chocolate has typical creamy texture and traditional long shelf life (e.g. 1 year) without bloom. In contrast, chocolate, which is made with dextrose incorporated before refine, conch, and/or tempering and subjected a thermal-curing post moulding, becomes dry and crumbly due to water released in the process and interacted with sugar (amorphous and crystalline) and/or protein during storage. Such chocolate also exhibits blooming due to cocoa butter de-tempering in the thermal treatments, a step that is omitted in the process of exemplary embodiments.

### EXAMPLES

The invention is further described in the context of the following examples, which are presented by way of illustration, not of limitation.

### Example 1

Dextrose monohydrate and cocoa butter was mixed at 38° C. in accordance with the weight parts shown in Table 1. The mixture was refined to a particle size of 19-22 μm with roller set at about 20° C. The refined material had temperature of about 28° C. as it came off the refiner. The moisture content of the refined material was measured at 6.28% wt., versus a calculated theoretical moisture content of 6.34% wt. based on the initial dextrose monohydrate which tested at 8.7% wt. moisture content, thus indicating that there was essentially no moisture loss during the refining process.

TABLE 1

| | |
|---|---|
| Dextrose monohydrate | 72.84 |
| Cocoa butter | 27.16 |
| Total | 100.00 |

### Example 2

Dextrose monohydrate and cocoa powder were dry blended in the weight parts shown in Table 2. The dry blend was pulverized to about 30 μm in conditions of approximately 20° C. and 50% relative humidity. The milled material leaving the pulverizer was about 25° C. The moisture content of jet pulverized dextrose/cocoa powder was 8.4% wt., indicating no moisture loss in the pulverization. The jet pulverized dextrose/cocoa powder was stored at room temperature for later use and did not exhibit lump formation.

TABLE 2

| | |
|---|---|
| Dextrose monohydrate | 95.0 |
| Natural cocoa powder | 5.0 |
| Total | 100.0 |

### Example 3

A weight loss method was used to observe water loss of jet pulverized dextrose monohydrate and cocoa power (97:3 weight ratio, with a particle size in the range of 32 μm to 36 μm) versus a control sample of commercially available unprocessed very fine (i.e. unpulverized of 65 μm-72 μm particle size) dextrose monohydrate powder over time at 30° C. and 35° C. The results are shown in Table 3.

TABLE 3

| | | | After 5 |
|---|---|---|---|
| | Initial | After 38 day at | day at |
| Samples | Moisture, % d.b. | 30° C. | 35° C. |
| Jet pulverized dextrose | 9.4 | 4.4 | 4.5 |
| monohydrate/cocoa powder | | | |
| (97:3 wt.), 32 μm-36 μm | | | |
| Commercial fine dextrose | 10.0 | 9.8 | 9.7 |
| monohydrate, 65 μm-72 μm | | | |

The results of Example 3 indicated that jet pulverized dextrose monohydrate/cocoa powder lost about 52% of the total water in 5 days at 35° C. while the very fine unpulverized dextrose monohydrate only lost 3% of its original moisture. At 30° C. jet pulverized dextrose powder was more stable, it took 38 days to loss about the same amount of water as that in 5 days at 35° C. After 38 days, the powder losses water at the same pace as unprocessed dextrose powder. This indicated that the process of jet pulverizing liberates portion of water from dextrose monohydrate which enables developing of heat stability at lower temperature without a post thermal treatment.

### Example 4

A weight loss method under vacuum was used to observe water loss of the roller refined dextrose monohydrate/fat blend of Example 1 compared to the same unprocessed, commercially available unrefined dextrose monohydrate powder used for comparison as Example 3. Samples were subjected to a vacuum of 0-4 in. Hg to a constant weight.

TABLE 4

| | Roller refined material from Example 1 | Commercial |
|---|---|---|
| | (Calculated theoretical moisture | dextrose |
| Samples | 6.34% wt.) | monohydrate |
| 40° C. | 4.76% wt. | 0.14% wt. |
| moisture reading | | |
| 45° C. | 6.28% wt. | 8.81% wt. |
| moisture reading | | |

The results of Example 4 indicated that roller refined dextrose/fat mixture released about 75% of its original water from dextrose at 40° C. as compared with about 1.6% for unrefined dextrose. Roller refined dextrose was ready to release water from its molecule similar to jet pulverized dextrose powder.

### Example 5

Milk chocolates were made with the following formulas using traditional chocolate process to obtain a standardized chocolate paste. Examples 5A and 5C contained jet pulverized dextrose monohydrate/cocoa powder, and Example 5B contained unrefined fine dextrose monohydrate powder as a comparative example. The parts by weight for each formulation are shown in Table 5, which also shows stages in the process at which the various ingredients were added.

TABLE 5

| | Ex. 5A | Ex. 5B | Ex. 5C |
|---|---|---|---|
| Ingredients | wt % | wt % | wt % |
| Batching for Refine | | | |
| Sugar | 37.64 | 37.74 | 44.05 |
| Chocolate Liquor | 11.60 | 11.63 | 12.84 |
| NFDM | 19.33 | 19.38 | 11.11 |
| WMP | | | 8.02 |
| AMF | 4.01 | 4.02 | 0 |
| Vanillin | 0.02 | 0.02 | 0.02 |
| Cocoa butter | 13.09 | 13.12 | 15.08 |
| At conch & standardize | | | |
| Lecithin | 0.29 | 0.30 | |
| Ammonium phosphatide (YN) | | | 0.21 |
| PGPR | 0.06 | 0.06 | 0.17 |
| Cocoa butter | 4.91 | 4.92 | |
| AMF | | | 4.50 |
| After tempering | | | |
| Jet pulverized dextrose/cocoa power | 7.46 | | 4.0 |
| (97:3) | | | |
| Lecithin | 0.34 | 0.24 | |
| PGPR | 0.28 | 0.12 | |
| Cocoa butter | 0.97 | 0.97 | |
| Fine dextrose monohydrate powder | | 7.48 | |
| Total | 100.00 | 100.00 | 100.00 |
| Total fat | 30.20 | 30.03 | 29.14 |

In Ex. 5A and 5B, batched material was mixed and refined to 18 μm-20 μm, then conched at 50° C. for one hour and standardized with additional fat and emulsifiers as formulated. The standardized chocolate pastes had apparent viscosity of 9100 cp and 9850 cp for the paste to contain the pulverized dextrose monohydrate (Ex. 5A) and unpulverized dextrose monohydrate (Ex. 5B), respectively, as measured with a Brookfield Rheometer spindle #27 at 20 rpm and 40° C.

The standardized chocolate paste was tempered and jet pulverized dextrose/cocoa powder at 97:3 wt ratio (Ex. 5A) or commercially available very fine unpulverized dextrose monohydrate (Ex. 5B) was mixed in a Hobart mixer with additional emulsifiers and cocoa butter as formulated.

To check heat stability of both pastes, the pastes were poured into several 4 oz cups and the cups covered with screw-on caps to prevent moisture loss. The sample cups were allowed to sit at a temperature of 22° C. for 3-5 days, then some cups were transferred to a temperature of 40° C. while others were transferred to a temperature of 49° C., both for intervals of 7 h, 24 h, and 48 h. The resulting structure was measured with a Brookfield R/S Plus Rheometer using vane probe of size 20-10 3 to 1 or 10-05 3 to 1. A constant rotation at speed of 0.2 l/min was used, the maximum shear stress was recorded as yield value in Pascal (Pa). The higher the yield value, the more structure developed in the chocolate, and the higher heat stability the chocolate has. A chocolate with yield value of about 2500 Pa had significant structure to hold its shape in wrapper; at 6000 Pa the chocolate was firm and able to pick up with fingers after unwrapped. For comparison purposes, a traditional non-heat stable chocolate has a yield value<250 Pa with this test method.

For Ex. 5C, batched material was mixed and refined to 20-22 μm, conched at 70° C. for 3 h, then standardized to 7300 cp. The standardized chocolate was tempered and jet pulverized dextrose was mixed in. The final paste was poured into several 4 oz cups and the cups covered with screw-on caps to prevent moisture loss. The cups were allowed to sit at a temperature of 22° C. for 5 days, then at either 35° C. or 40° C. again for time periods of 7 h, 24 h, and 48 h and structure development was measured as described previously and recorded as shown in Tables 5-a and 5-b:

TABLE 5-a

| | Yield at | Yield at | Yield at | Yield at | Yield at | |
|---|---|---|---|---|---|---|
| | 40° C./ | 40° C./ | 40° C./ | 49° C./ | 49° C./ | Yield at |
| | 7 h,, | 24 h, | 48 h, | 7 h, | 24 h, | 49° C./48 h, |
| Sample | Pa | Pa | Pa | Pa | Pa | Pa |
| Ex. 5A | 829 | 2544 | 4651 | 6402 | 15532 | 20070 |
| Ex. 5B | 502 | 529 | 793 | 966 | 3537 | 7637 |

TABLE 5-b

| | Yield at | Yield at | Yield at | Yield at | Yield at | |
|---|---|---|---|---|---|---|
| | 35° C./ | 35° C./ | 35° C./ | 40° C./ | 40° C./ | Yield at |
| Sample | 7 h | 24 h | 48 h | 7 h | 24 h | 40° C./48 h |
| Ex. 5C | 934 | 1985 | 2799 | 1632 | 3026 | 4629 |

The data in tables 5-a and 5-b showed that chocolate pastes (Exs. 5A and 5C) made with jet pulverized dextrose monohydrate/cocoa powder had significantly more structure development than that of the control using unprocessed dextrose (Ex. 5B), indicating that water was liberated at lower temperature in jet pulverized dextrose.

### Example 6

A white chocolate was made with the formula shown in Table 6 using a traditional chocolate process to obtain a standardized chocolate paste.

TABLE 6

| | White chocolate |
|---|---|
| Ingredients | wt % |
| Batching for Refine | |
| Sugar | 39.56 |
| NFDM | 17.23 |
| WMP | 6.70 |
| AMF | 2.20 |
| Vanillin | 0.02 |
| Cocoa butter | 20.12 |
| At conch & standardize | |
| Lecithin | 0.30 |
| PGPR | 0.03 |
| Cocoa butter | 4.79 |
| After tempering | |
| Jet pulverized dextrose/cocoa power | 7.74 |
| (97:3) | |
| Lecithin | 0.21 |
| PGPR | 0.13 |
| Cocoa butter | 0.97 |
| Total | 100.00 |
| Total fat | 30.62 |

Batched material was mixed and refined to about 22 μm, then conched at 50° C. for one hour and standardized with additional fat and emulsifiers as formulated. To make a heat stable chocolate, the standardized chocolate paste was tempered and jet pulverized dextrose/cocoa powder (97:3 wt) was mixed in a Hobart mixer with additional emulsifiers and cocoa butter as formulated. The final chocolate pastes had an apparent viscosity of 12,650 cp as measured with a Brookfield Rheometer spindle #27 at 20 rpm and 40° C.

The heat stability of the white chocolate was checked using the same method as described in Example 5. Yield value was recorded Table 6-a:

TABLE 6-a

| | Yield at | Yield at | Yield at | Yield at |
|---|---|---|---|---|
| | 40° C./ | 40° C./ | 49° C./ | 49° C./ |
| | 7 h, Pa | 24 h, Pa | 7 h, Pa | 24 h, Pa |
| White | 1736 | 3543 | 26972 | 42664 |
| chocolate | | | | |

Data in the table above showed that the white chocolate developed significant amount of structure after 24 h at 40° C., and even more at 49° C./7 h and 49° C./24 h, indicating jet pulverized dextrose released water at lower temperature.

### Example 7

For this example, a milk chocolate compound was prepared using a roller refined dextrose monohydrate/cocoa butter paste having the formula shown in Table 7.

TABLE 7

| | Compound | Refined dextrose | Final |
|---|---|---|---|
| Ingredients | paste, % | powder, % | Blend, % |
| Sugar | 40.00 | | |
| Cocoa powder | 12.6 | | |
| NFDM | 16.97 | | |
| Palkena HA3 | 30 | 22.76 | |
| Vanillin | 0.03 | | |
| Lecithin | 0.3 | | 0.10 |
| PGPR | 0.1 | | |
| Dextrose monohydrate | | 70.22 | |
| Cocoa butter | | 7.02 | |
| Compound paste | | | 85.23 |
| Refined Dextrose | | | 14.67 |
| powder | | | |
| Total | 100.0 | 100.0 | 100.0 |
| Total fat, % | 31.8 | 29.7 | 31.50 |

To make the compound paste, all ingredients except lecithin, PGPR, and 1.5% of the Palkena HA3, were mixed and refined to 25-30 μm. The refined powder was conched and standardized with addition of lecithin, PGPR, and remaining fat at about 38° C.

The refined dextrose powder was made by mixing all three ingredients shown in that column and the mixture was refined in a roller refiner to 25-30 μm at a 19° C. refiner temperature.

The compound paste and refined dextrose powder were mixed at 35° C. in formulated ratio shown in the final column using a Hobart mixer and the resulting product was then moulded into pieces and stored at 18° C./50% RH for 1 week. Heat stability was measured at 40° C. using Tax-T2 texturometer after sample was stored at 35° C. for 2 h and 40° C. for about 16 h. A compression program with 5 mm cylinder probe and penetrating 2.5 mm at 0.2 mm/sec was used. A peak force of about 100 g indicated a chocolate piece being able to pick up without being sticky. For comparison, a traditional, non-heat stable chocolate had a peak force of less than 10 g. The heat stability data for Example 7 is shown in Table 7-a.

TABLE 7-a

| | | Peak Force |
|---|---|---|
| Sample | Peak Force (g) at 35° C./2 h | (g) at 40° C./16 h |
| Compound with | 46 | 141 |
| dextrose refined | | |

### Example 8

The milk chocolate and chocolate compound pastes shown in Table 8 were formulated to demonstrate the effect of reduced sized sugar hydrates in combination with amorphous sugars in the context of pre-sized dextrose monohydrate and amorphous lactose in non-fat milk powder as measured by positive glass transition energy.

A DSC method was developed to measure the glass transition energy of amorphous lactose in milk powders, such as NFDM and WMP. This method can also be applied to other dairy ingredients such as whey powders, milk permeates, and chocolate paste. The DSC method includes a DSC program carried out on Q2000 TA Instruments, and uses TA Universal Analysis 2000 for data analysis. The DSC program includes equilibrating at 10° C.; modulating +/−1° C. every 60 s; isothermal for 3.00 min; and ramping 1.00° C./min to 100° C.

To measure chocolate sample, the chocolate was melted and kept at 35° C. 10-20 mg was weighed into a hermetic pan then sealed with a lid. The sample pan was transferred to DSC instrument and run with preset program. Glass transition thermal event was recorded and analyzed.

A commercial whole milk powder had glass transition energy of 0.2429 J/g.° C. at midpoint temperature 49.7° C. and a commercial NFDM had a glass transition energy of 0.2988 J/g.° C. of at midpoint temperature 53.7° C.

When pre-sized dextrose was incorporated in a milk chocolate containing amorphous lactose of glass transition (G.T.) energy>0.02 J/g.° C. and a midpoint temperature of 50° C.-70° C., the chocolate exhibited better heat stability. A milk chocolate made with pre-sized dextrose and amorphous lactose with glass transition energy of 0.066 J/g.° C. and midpoint of 59.5° C. had better heat stability than that of amorphous lactose with glass transition energy of 0.028 J/g.° C. and midpoint of about 50° C.

TABLE 8

| | Ex. 8A, | Ex. 8B, G.T. |
|---|---|---|
| | G.T. Energy | Energy 0.028 J/g. |
| Ingredients | 0.066 J/g.° C. | ° C. |
| Sugar | 38.96 | 43.65 |
| Liquor | 12 | 0 |
| Cocoa powder | 0 | 7 |
| NFDM | 20 | 9 |
| Lactose | 0 | 5.6 |
| Cocoa butter | 19.34 | 0 |
| AMF | 3.35 | 0 |
| Palkena HA3 | 0 | 28.4 |
| Vanillin | 0.02 | 0.02 |
| Lecithin | 0.3 | 0.3 |
| PGPR | 0.03 | 0.03 |
| Jet pulverized dextrose/cocoa | 6 | 6 |
| (97:3) | | |
| Total | 100.0 | 100.0 |
| Total fat | 29.5 | 29.5 |
| Heat stability at 35° C./7 h, yield | 8466 | |
| value, Pa | | |
| Heat stability at 40° C./24 h, yield | | 1638 |
| value, Pa | | |

The chocolate (Ex. 8A) and compound (Ex. 8B) pastes were made by premixing, refine, conch, and standardize with jet pulverized dextrose/cocoa powder left for later addition as described herein. In the chocolate paste (Ex. 8A), jet pulverized dextrose/cocoa powder was blended in Hobart mixer after tempering. In case of compound (Ex. 8B), the paste was cooled to 32° C. and the jet pulverized dextrose powder was mixed in with Hobart mixer.

Heat stability was measured using vane yield method as described above. Chocolate of 0.066 J/g.° C. glass transition energy had yield value of 8466 Pa and was firm to pick up at 35° C. for 7 h, whereas compound of 0.028 J/g.° C. glass transition energy had yield value of 1638 Pa and was soft even at 40° C. for 24 h, however there was still more structure than traditional non-heat stable chocolate (<250 Pa).

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for creating a heat stable confectionery product comprising:
carrying out a first process sequence comprising
formulating a blend of a sweetener and a confectionery fat, the blend further including milk solids, cocoa solids or both, and
conching the blend;
providing a sugar hydrate additive;
adding the sugar hydrate additive at the completion of the first process sequence to form a flowable paste; and
cooling the paste to a solid.

2. The method of claim 1, wherein the sugar hydrate additive consists of a sugar hydrate.

3. The method of claim 1, wherein the sugar hydrate additive comprises a sugar hydrate.

4. The method of claim 3, wherein the sugar hydrate is processed to a particle size less than 60 microns.

5. The method of claim 4, wherein processing the sugar hydrate to a particle size less than 60 microns is selected from the group consisting of roll refining and jet milling.

6. The method of claim 3, wherein the sugar hydrate comprises dextrose monohydrate.

7. The method of claim 6, wherein the dextrose monohydrate is processed to a particle size less than 60 microns under process temperatures of about 35° C. or less.

8. The method of claim 7, wherein the dextrose monohydrate has a dehydration temperature of less than 40° C.

9. The method of claim 3, wherein providing the sugar hydrate additive further comprises blending the sugar hydrate with an additional confectionery fat and at least one emulsifier.

10. The method of claim 9, wherein the additional confectionery fat is present from about 22% to about 35% by weight of the sugar hydrate.

11. The method of claim 9, wherein the at least one emulsifier is selected from the group consisting of lecithin, polyglycerol polyricinoleate (PGPR), ammonium phosphatide (YN), and combinations thereof.

12. The method of claim 3, wherein providing the sugar hydrate additive further comprises blending the sugar hydrate with a flow-aid.

13. The method of claim 12, wherein the flow-aid is present at up to about 10% by weight of the sugar hydrate.

14. The method of claim 1, wherein the first process sequence further comprises tempering the blend after the step of conching.

15. The method of claim 1, wherein the first process sequence further comprises standardizing the blend after the step of conching.

16. The method of claim 1, wherein the sweetener of the first process sequence comprises sucrose and an amorphous sweetener, the amorphous sweetener present as at least four percent by weight of the flowable paste.

17. The method of claim 1, wherein the flowable paste includes from about 2% to about 20% by weight dextrose monohydrate, the dextrose monohydrate being pre-sized and having a water equivalent of about 0.18% to about 1.80%.

18. The method of claim 1, wherein the step of cooling the paste to a solid forms the heat stable confectionery product without any post production thermal treatment.

19. The method of claim 1, wherein the first process sequence further comprises refining the blend intermediate the steps of formulating and conching.

20. The method of claim 1, wherein the step of formulating in the first sequence comprises formulating the blend using at least one pre-ground ingredient.

21. The method of claim 1, wherein the first process sequence comprises ball milling the blend intermediate the steps of formulating and conching.

22. The method of claim 1, wherein the blend comprises the sweetener, the confectionery fat and the milk solids, wherein the milk solids include whole milk powder, non-fat dry milk powder, or a combination thereof.

23. The method of claim 22, wherein the blend further comprises cocoa solids.

24. The method of claim 1, wherein the blend comprises the sweetener, the confectionery fat and cocoa solids.

25. The method of claim 1 further comprising forming the paste prior to the step of cooling.

26. A heat stable confectionery product formed according to the method of claim 1, the heat stable confectionery product including a sugar hydrate and being visibly devoid of blooming.

27. A method for creating a heat stable confectionery product comprising:
carrying out a first process sequence comprising
formulating a blend of a sweetener and a confectionery fat, the blend further including milk solids, cocoa solids or both, and
conching the blend; thereafter
adding a sugar hydrate additive including dextrose monohydrate at the completion of the first process sequence to form a flowable paste; and
cooling the paste to a solid, the cooling of the paste forming the heat stable confectionery product without any post production thermal treatment;
wherein the step of providing the sugar hydrate additive includes pre-sizing the sugar hydrate to a smaller particle size, the smaller particle size reducing a dehydration temperature of the sugar hydrate; and
wherein the step of providing the sugar hydrate additive optionally includes blending the dextrose monohydrate with at least one of a flow-aid and an additional confectionery fat.
